(19) United States
(12) Patent Application Publication
(10) Pub. No.: US 2006/0282831 A1
(43) Pub. Date: Dec. 14, 2006

(54) Method and hardware node for customized upgrade control

(76) Inventor: Maria Toeroe, Montreal (CA)

Correspondence Address: Alex Nicolaescu;Ericsson Canada Inc., Patent Department, 8400 Decarie Blvd., Town Mount Royal, QC, H4P 2N2, CA

(21) Appl. No.: 11/139,565

(22) Filed: May 31, 2005

(51) Int. Cl. G06F 9/44

(52) U.S. Cl. 717/168

(57) ABSTRACT

A method and hardware node for carrying out a customized upgrade process of an application module or a platform module is provided. Modules interested in receiving notifications about upgrade processes register their interest with an upgrade manager. The manager is then provided with a set of instructions, such as a script, that associate certain criteria with notifications to be transmitted to interested application modules, which registered with the upgrade manager. When an upgrade of an application module is initiated, the manager determines whether the criteria is satisfied and if so, sends the proper notifications to the registered modules, which may take appropriate action, such as executing a given task or adapting their behaviour taking into consideration the ongoing upgrade process. The invention is for both standalone hardware nodes implementing application module(s) and for redundant, distributed or cooperating applications of high availability systems.

### BACKGROUND OF THE INVENTION

1. Field of the Invention

The present invention relates to a method and system for performing customized upgrades.

2. Description of the Related Art

In information technology, High Availability (HA) refers to a system or component that is almost continuously operational for a desirably long length of time. System availability can be measured relative to “100% operational” or “never failing.” A widely-held but difficult-to-achieve standard of availability for a system or product is known as “five 9s” (99.999 percent) availability that is also referred as highly available or HA system. Since a computer system or a network consists of many parts, which usually need to be present in order for the whole to be operational, much planning for high availability centers around backup and failover processing and data storage and access. For storage, a redundant array of independent disks (e.g. RAID) is one approach.

A typical application of high availability systems consist of communications systems such as mobile telecommunications networks, where network operators need that the service provision be almost permanent, i.e. with as minimal interruption as possible. In order to achieve this goal, many applications used in telecommunications systems are distributed, i.e. replicated at different locations so that they can work as complementary, redundant applications. Thus, in order to achieve high availability, applications are typically configured to run in a distributed and redundant architecture over redundant hardware.

However, in an architecture with distributed applications with redundant functionality, highly available system applications or even the operating system platforms sometimes still need to be upgraded without interrupting the provision of the services offered by the application. This also means that during the upgrade procedure, there is a time period during which a first hardware acting as a primary service node will run, for example, the old version of an application or of an operating system platform while the second redundant service node will run, for example, the new version of the application or the platform. During this period of time, two versions of the same software will coexist and in many systems, such as for example in the case of distributed applications or redundant application, the different version of the applications will also have to interact with each other properly, thus they need to be aware of this differences. However, it is typical that the application and the platform are decoupled during the upgrade process of the application, and during that time it is the platform that takes care of the upgrade procedure itself. Therefore, the live application may not be aware of the progress of the upgrade of its cooperating application, even though in many circumstances its actions may need this knowledge and that the upgrade may be smoother with this knowledge.

For example, if two redundant hardware nodes are initially configured with the same software application that is run in order to provide a given service to cellular subscribers, and that during normal operation the nodes synchronize their information at regular intervals, and at a given time an upgrade procedure is started at the second node, during the upgrade procedure the control is given to the platform of the second node so that, as a result, the application in the process of being upgraded cannot fulfill its synchronization tasks.

Many other situations exist where an application in the process of being upgraded cannot fulfill its tasks.

A partial solution offered by some systems is to predefine at the system-level a sequence of stages that any upgrade process will go through, and that will be signaled to the application by the platform during the upgrade process. In that manner, any application that needs to be upgraded will tie its actions to these predefined stages.

However, it was noticed that applications upgrades may require a different set of stages then what is provided by distributed system platforms and may further require control of the upgrade procedure beyond the framework specified by the system-level. Moreover, even if a series of stages is defined for an application to go through during its upgrade process, it was noticed that this is not sufficient for guaranteeing the application's high availability for all possible upgrades. On the other hand, the requirement of high availability limits the types of upgrades that can be performed on some applications (e.g. databases).

A similar problem was also noticed for a standalone application, which also becomes unavailable during an ongoing upgrade process.

Although there is no prior art solution as the one proposed hereinafter for solving the above-mentioned deficiencies, the US patent publication number 2004/054943 bears some relation with the field of the present invention. In this publication, there is taught a high availability application provision method for a network-based computer system, which involves editing a finite state table, based on solution architectures and changing configuration obtained by simulation. A finite state table related to each high availability application, is defined. Based on the solution architectures, the table is edited and the configuration of the table is changed by simulation. This solution enables regulating the process groups' availability corresponding to the system failure, due to effective configuration of finite state tables. It also simplifies the installation of high availability applications and redesigning of application at low cost, even for a wide range of solution architectures.

The U.S. Pat. No. 6,618,805 further teaches an upgrade method for high-availability computer system, which involves applying an associated progress rule if a computer system fails to reach a specified stable target configuration. In this patent, there is taught a succession of stable target configuration specifying the state of several components of a computer system, and a progress rule for each target configuration. The system is driven from the current stable target configuration to the next configuration specified in succession. If the system fails to reach the next stable target configuration, an associated progress rule is applied. This is used for upgrading the distributed data processing system in high availability computer system. The system is upgraded by viewing the upgrading process between successions of stable configurations, hence if any of the operation fails, unwinding the operation is accomplished until an acceptable alternative configuration is reached. Therefore, even if the upgrade is not accomplished, the availability of the system is maintained.

Conclusively, none of the above-mentioned prior art provides a solution that improves the expected high availability of software applications, including operating system platforms, during an ongoing upgrade process by allowing for enhanced synchronization during an upgrade process between the platform and the application.

Accordingly, it should be readily appreciated that in order to overcome the deficiencies and shortcomings of the existing solutions, it would be advantageous to have a solution that provides high availability for both distributed applications and standalone applications during an ongoing upgrade process. The present invention provides such a is solution.

### SUMMARY OF THE INVENTION

According to the present invention there is provided a method and hardware node for carrying out a customized upgrade process of an application module or a platform module. Modules interested in receiving notifications about upgrade processes register their interest with an upgrade manager. The manager is then provided with a set of instructions, such as a script, that associate certain criteria with notifications to be transmitted to interested application modules, which registered with the upgrade manager. When an upgrade of an application module is initiated, the manager determines whether the criteria is satisfied and if so, sends the proper notifications to the registered modules, which may take appropriate action, such as executing a given task or adapting their behaviour taking into consideration the ongoing upgrade process. The invention is for both standalone hardware nodes implementing application module(s) and for redundant, distributed or cooperating applications of high availability systems.

In one aspect, the present invention is a method for upgrading a software application, the method comprising the steps of:

a. providing to an upgrade manager criteria information associated with at least one specified notification to be transmitted to at least one application module when the criteria is met;

b. initiating an upgrade process of an application module;

c. during the upgrade process, evaluating whether the criteria is met; and ___

d. when the criteria is met, sending out the at least one specified notification to the at least one application module.

In another aspect, the present invention is a hardware node comprising:

an upgrade manager adapted to receive and store criteria information associated with at least one specified notification to be transmitted to at least one application module when the criteria is met;

wherein the upgrade manager acts to initiate an upgrade process of an application module and during the upgrade process, to evaluate whether the criteria is met and when the criteria is met, to send out the at least one specified notification to the at least one application module.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level node diagram illustrative of a possible implementation of the preferred embodiment of the present invention;

FIG. 2 is a high-level block diagram of a hardware node where the preferred embodiment of the invention may be implemented; and

FIG. 3 is an exemplary flowchart diagram representative of the method for performing a customized upgrade process of an application module according to the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides a solution that enables software application modules to be upgraded in a manner that allows for the uninterrupted, or quasi-uninterrupted provision of the service provided by the application itself. The solution of the present invention is useful for both standalone applications as well as redundant applications distributed over multiple hardware nodes, which are typical in high availability applications. Customized upgrade according to the present invention allows application modules to participate actively in an upgrade process, as opposed to traditional upgrade known in the prior art where application modules were merely acted upon by an upgrade manager. The present invention allows for the elimination or quasi-elimination of service interruptions due to the unavailability of the application during an upgrade process.

Not only does the present invention allow for software application modules to be upgraded in an efficient manner, but also the same principle of the invention is also applicable for certain operating system platform modules, especially for the ones operating in a distributed environment, which may also be upgraded using the same technique.

According to the present invention, upgrade instructions such as for example an upgrade script is used to define the stages an application upgrade should go through and to specify the type of input (e.g. signals) that the application being upgraded can interpret to synchronize its behaviours with the progress of the upgrade. An upgrade manager interprets the upgrade instructions or script, and can signal to the application each stage of the upgrade process. The upgrade manager can also give the control back to the application so that the later can execute any necessary actions by suspending the upgrade process until the application completes its tasks and returns the control to the platform (i.e. to the Operating System OS). Once such a task is completed by the application, the later signals the upgrade manager of the platform to return the control to the upgrade manager, which then continues with the execution of the upgrade instructions until the next defined stage of the upgrade is reached, or until the end of the upgrade process. In this manner, an upgrade manager of the platform can provide a customized control throughout the application upgrade process for which the upgrade instructions or the script is provided.

According to the present invention, depending on the upgrade method to be utilized (e.g. rolling upgrade, split-mode upgrade, simultaneous upgrade), the application complexity and the level of incompatibility, multiple upgrade stages may be required to upgrade an application in a smooth manner without service interruption or degradation. An upgrade stage may be a set of conditions at which the application's action/intervention is required to further proceed with the upgrade. The method for upgrade of the present invention allows for the definition of the most appropriate upgrade scenario and for those triggering points within the upgrade process when at least one of the application modules needs to be called back with the appropriate input signalling informing about the progress of the upgrade and triggering an action from the application module, which may include, for example, the adjustment of the application's behaviour accordingly, or the processing of a given task. Thus, when certain conditions are met, the platform may give the control back to the application module being upgraded to perform a critical task, in which case the application executes the tasks and further calls the upgrade manager to inform it that the task has been finished and that it can safely continue to execute the upgrade instructions.

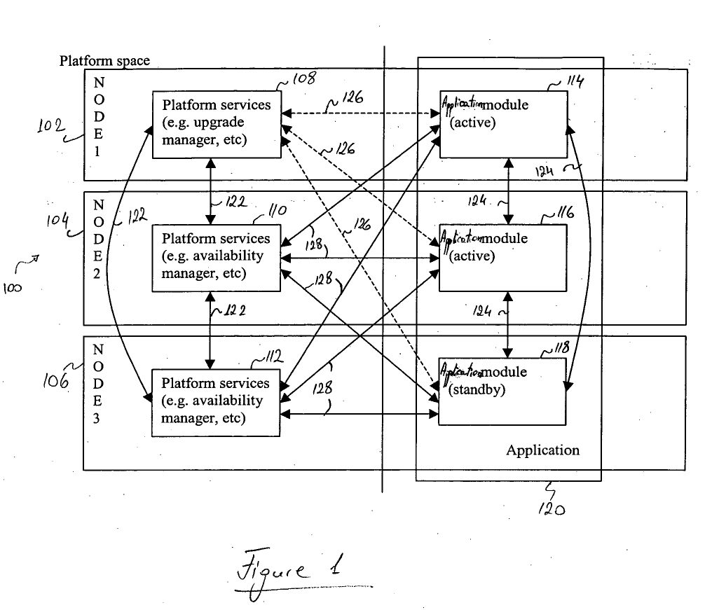

Reference is now made to FIG. 1, which is an exemplary high-level node diagram illustrative of a possible implementation of the preferred embodiment of the present invention. FIG. 1 shows exemplary typical actors of a high availability system 100 providing highly available services via three hardware nodes 102, 104, and 106 that run platforms (OSs) 108, 110, and 112 respectively, as well as application modules 114, 116, and 118 respectively. Application modules 114-118 may be of various types, such as for example high availability redundant applications or cooperating application modules that together function for the provision of a given service. Together, application modules 114-118 constitute the application part 120 of the high availability system 100. Because the high availability system 100 is distributed over multiple nodes 102-106, the respective platforms 108-112 are connected with each other via communications links 122, so that platform control and signalling can be performed. Likewise, because applications modules need to exchange information with each other, such as for example in synchronising their internal information in case of redundant applications, or exchanging data in the case of cooperating applications, the applications modules 114-118 are also connected with each other via communications links 124. Also, application modules 114-118 are controlled by the platform services 108-112 via control communications links 126 and 128. Shown in dotted lines are the control communications links 126 through which takes place the control communication for the upgrade control according to the preferred embodiment of the present invention, between an upgrade manager of the platform 108 and application modules 114, 116, and/or 118. The traditional control signalling links 128 are shown in solid lines and may be used for heartbeat signalling, life cycle control, and those actions necessary to use platform services such as messaging, event service, check-pointing etc.,

A typical way of providing high availability services is via redundancy and accordingly in FIG. 1, one of the possible implementations is the application part 120 with modules 114-118 of the application part 120 being distributed over multiple nodes, wherein some of the modules (e.g. modules 114 and 116) perform an active role, which means that they are currently in operation and providing a given service, while others (e.g. module 118) act as standby application modules for the active modules. The role active or standby may be assigned to a given application module by the availability management service of the platform, which may be included in the platform modules. Similarly, the upgrade of an application module is controlled from the platform side by an upgrade management service, also called herein an upgrade manager, which is a functionality included in at least one of the platform modules 108-112 (in the present example it is the platform module 108 which contains the upgrade manager). The redundancy and the communications among the platform services are transparent for the application and may be performed in various manners, as it is known in the art. On the other hand, the platform is aware only the lifecycle (availability, upgrade state) of the different application modules. It may have no insight how the lifecycle operations impact the functionality and the service that the application module is providing.

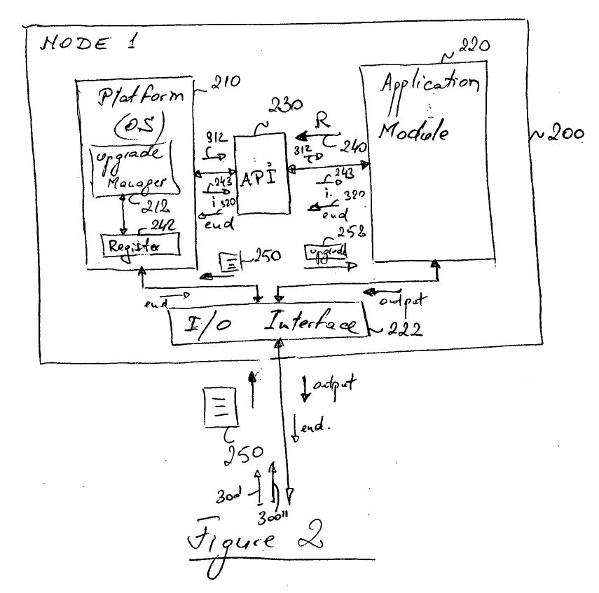

Reference is now made to FIG. 2, which is a high-level block diagram of a hardware node 200 where the preferred embodiment of the invention may be implemented. The hardware node 200 shown in FIG. 2 may be a non-redundant, standalone hardware node implementing a given service. Alternatively, the hardware node is 200 may be a redundant node alike any one of nodes 102-106 described previously in relation to FIG. 1. The node 200 comprises a platform 210 on which runs an application module 220. Both the platform and the application 220 communicate externally via the input/output (I/O) interface 222 to which they are connected via appropriate connections.

In the case the node 200 is a standalone hardware node implementing a non-redundant application 220, the I/O interface 22 is adapted to receive messages from outside components (e.g. other nodes, other networks, LAN, WAN, Internet, etc) and to relay messages to these outside components, based on the nature and the functioning of the application module 220.

In the case the node 200 is a high availability redundant hardware node implementing a distributed redundant application 220, the I/O interface 22 is adapted not only to receive and relay messages from outside components but also to support communications with the redundant hardware nodes, i.e. to implement a communications interface 126 as shown in relation to FIG. 1.

The platform 210 also contains an upgrade manager 212 responsible for controlling an upgrade process of the application 220. The platform 210 and the application module 220 are connected with each other via an Application Programming Interface (API) 230, via which application modules can register their interest for a call-back procedure during their own upgrade process. A call-back procedure in the context of the present invention is a notification regarding a given condition that is met in relation to the application. Such application modules may include local application module that run on the hardware node 200, such as for example the application module 220, or redundant application modules running on other redundant hardware nodes, as shown in FIG. 1.

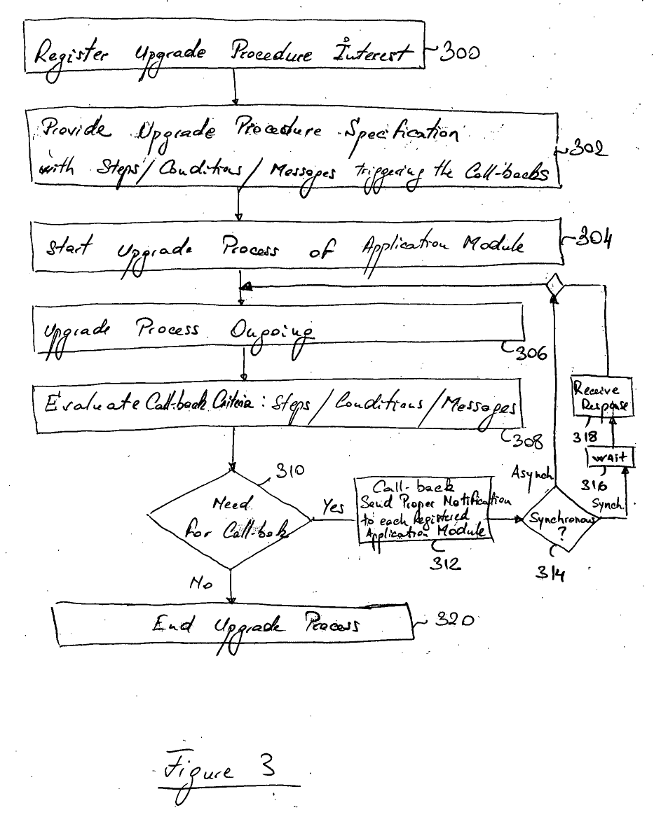

Reference is now made jointly to FIG. 2, previously described, and to FIG. 3, which is an exemplary flowchart diagram representative of a method of performing a customized upgrade process of an application module according to the preferred embodiment of the present invention. First, in action 300, the application module 220 registers its interest with the upgrade manager 212 in call-backs, i.e. in notifications of possible upgrade procedures, by issuing a Register message 240 sent to the upgrade manager 212 of the Platform 210. The Register message 240 is received and stored in the Registry 242 of the Platform 210. From this moment on, if an upgrade process is to take place, the application module 220 should be notified.

Action 300 may also include the receipt of other registrations 300′ and 300″ coming from other application modules which desire to signal their interest to be notified in case of any subsequent upgrade process, such as for example from distributed and redundant application modules alike those shown in FIG. 1. As a result, these registrations are also stored in the Registry 242 of the upgrade manager 242.

In action 302, an upgrade procedure is specified with the criteria (e.g. at what steps of the upgrade process, or based on which conditions, or upon receipt of what type of messages) based on which a notification is to be sent to the application modules that registered their interest in call-backs. The criteria information may comprise instructions 250 that may be in the form of an executable script that is to be interpreted by the upgrade manager 212, or a set of manual instructions provided by an operator to execute a manual upgrade. In this latter case, the operator may be able to provide the identifying steps/conditions/messages of interest to the upgrade manager 212 so they can be delivered to the application modules. This criteria information may specify conditions, steps, or signals with their associated notifications that are to be transmitted to particular registered application modules.

In action 304, and upgrade procedure is started for the application module 220. Thereafter, in action 306 the upgrade process is ongoing so that the application module 220 is being upgraded from an old version to a new version the upgrade manager 212 interprets the upgrade instructions (e.g. the executable script) step by step to identify if any of the criteria is met for notifying an application module, action 308. Part of action 304 may also be the provision of an upgrade data package 252 being sent for the upgrade.

In action 308, the upgrade manager 212 identifies, possibly on a continuous or regular basis, if any of the call-back criteria specified in action 302, i.e. if any of the steps/conditions/messages of interest, are satisfied. If certain criteria are met in action 310, the application module 220 that registered interest for the call-back, as well as any other application module which registered its interest with the upgrade manager as described in step 300, receives a specified notification (also called herein a condition signal) from the upgrade manager 212, action 312, as described in the upgrade procedure of step 302. Application module 220 interprets the specified notification based on its own internal procedure and settings to perform application specific actions such as for example to convert data format or change behaviour (e.g. start logging) of the application module. The notification of action 308 may comprise the transmission of information from the application manager 212 to the application module 220 for informing that a certain condition is met, that a certain step of the upgrade process is reached, or that a certain message of interest was received, and that some processing is required from the application module 220 based on that criteria. For example, a message of interest may be received by the hardware node 200 that would necessitate processing and the issuance of a response by the application module 220. In that case, the application module 220 which registered its interest in receiving the notification is informed by the upgrade manager 212 of the receipt of the message of interest, and control is given back to the application module 220 for processing the incoming message of interest and for issuing a proper response.

Generally, depending on the upgrade instructions, the upgrade manager 212 may wait for a response from the application module 220 to which it sent a notification before continuing with the upgrade process. Thus, in action 314 the upgrade manager 212 evaluates whether or not a response is being expected from the application module 220 to which control has been given back, and if so, waits for a specified period of time for a response, action 316, which is issued in action 318 before the upgrade manager 212 receives back the control and continues with the upgrade process. Otherwise, in case of asynchronous processing when no response is expected at the moment from the application module 220, the upgrade manager 212 receives back the control and continues with the upgrade process. In some cases, a response may be expected, but it may come at a later point in time, so that it will be evaluated at subsequent synchronization point of is the upgrade procedure.

If there are more steps in the upgrade instructions, the upgrade continues by going again through steps 306, 308 and 310, as described hereinbefore. Otherwise it terminates, action 320.

With reference being now made concomitantly to FIGS. 1, 2, and 3, previously described, it is to be noted that various implementations of the present invention may exist. For example, in a first variant it is possible that all application modules being resident on a given platform, or all applications being linked together as cooperating or redundant applications would receive the notification (the condition signal message) about the call-back procedure. In such an implementation, with reference being made jointly to FIGS. 2 and 3, action 300 is skipped. Since it is the application modules themselves that determine and interpret the incoming signals, only application modules of the same application will correctly interpret those signals and initiate the call-back procedure, while all other application modules will discard the incoming messages.

In some cases, different applications may be interested in having knowledge about an upcoming upgrade process as they might be impacted by it. For example, if a node needs to be rebooted to proceed with the upgrade of a given application module, all application modules running on this node will be impacted. For these cases some well-known signals (e.g. upcoming reboot signal) can be specified that all modules understand and can interpret the same way. For example, before starting an upgrade process, the upgrade manager 112 may require all affected application modules to finish any critical operation and not to start new ones by signalling them to prepare for an upgrade using such a message.

In another variant of the preferred embodiment of the present invention, it is not only application modules that may register their interest with the upgrade manager for call-back procedures (notifications about upgrades), but also redundant platform modules of redundant hardware nodes. For example, with reference being made jointly to FIG. 1 and 3, an availability manager module of the platform 110 of the node 104 may register its interest in a call-back procedure with the upgrade manager of the platform 108 of the node 102, in action 300. Actions 302, 304, 306, 308, 310 are performed as described previously, and in action 312 the upgrade manager of the platform 108 sends the proper notification to the platform 110 for informing about the specified criteria being met. This enables also the platform 110 to take appropriate actions based on the information received, e.g. to perform some specified tasks or to adapt its behaviour in light of the ongoing upgrade.

Therefore, with the present invention it becomes possible to upgrade an application module or a platform module, together generically designated under the terminology of application module herein below, in a manner transparent or quasi-transparent to cooperating applications, to redundant application modules, or to users. For example, if there is a need for utilising an application module being upgraded, that need is signalled to the application module by the upgrade manager, and control is given back temporarily to the application module for performing the required task and possibly issuing an output. Then, the control is taken over again by the upgrade manager for completing the upgrade. In this manner, the present invention allows for the elimination or quasi-elimination of service interruptions due to the unavailability of the application during the upgrade process.

Based upon the foregoing, it should now be apparent to those of ordinary skills in the art that the present invention provides an advantageous solution for application module upgrades, which is applicable to both distributed applications and standalone applications. Although the system and method of the present invention have been described in particular reference to certain exemplary scenarios, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for upgrading a software application, the method comprising the steps of:
a. providing to an upgrade manager criteria information associated with at least one specified notification to be transmitted to at least one application module when the criteria is met;
b. initiating an upgrade process of an application module;
c. during the upgrade process, evaluating whether the criteria is met; and
d. when the criteria is met, sending out the at least one specified notification to the at least one application module.

2. The method claimed in claim 1, further comprising the steps of:
e. receiving the specified notification by the at least one application module; and
f. performing an action based on the specified notification.

3. The method claimed in claim 1, further comprising the step of:
g. registering an interest of the at least one application module for receiving notifications in relation with an upgrade process.

4. The method claimed in claim 2, wherein the specified criteria comprise at least one condition.

5. The method claimed in claim 2, wherein the specified criteria relate to at least one message of interest.

6. The method claimed in claim 2, wherein the specified criteria relate to a stage of the upgrade process of the application module.

7. The method claimed in claim 2, wherein the action comprises temporarily suspending the upgrade process for the action to be performed.

8. The method claimed in claim 2, wherein the at least one application module is for providing a given service.

9. The method claimed in claim 2, wherein the at least one application module comprises an operating system platform module.

10. A hardware node comprising:
an upgrade manager adapted to receive and store criteria information associated with at least one specified notification to be transmitted to at least one application module when the criteria is met;
wherein the upgrade manager acts to initiate an upgrade process of an application module and during the upgrade process, to evaluate whether the criteria is met and when the criteria is met, to send out the at least one specified notification to the at least one application module.

11. The hardware node claimed in claim 10, wherein the specified notification is received by the at least one application module which performs an action based on the specified notification.

12. The hardware module claimed in claim 11, further comprising the at least one application module.

13. The hardware node claimed in claim 10, wherein the at least one application module registers its interest for receiving notifications in relation with an upgrade process.

14. The hardware node claimed in claim 1 1, wherein the specified criteria comprise at least one condition.

15. The hardware node claimed in claim 1 1, wherein the specified criteria relate to at least one message of interest.

16. The hardware node claimed in claim 1 1, wherein the specified criteria relate to a stage of the upgrade process of the application module.

17. The hardware node claimed in claim 1 1, wherein the action comprises temporarily suspending the upgrade process for the action to be performed.

18. The hardware node claimed in claim 11, wherein the at least one application module is for providing a given service.

19. The hardware node claimed in claim 1 1, wherein the at least one application module comprises an operating system platform module.
